(19) United States
(12) Patent Application Publication
(10) Pub. No.: US 2005/0138478 A1
(43) Pub. Date: Jun. 23, 2005

(54) Error detection method and system for processors that employ alternating threads

(76) Inventors: Kevin D. Safford, Fort Collins, CO (US); Donald C. Soltis JR., Fort Collins, CO (US); Stephen R. Undy, Fort Collins, CO (US); James D. Gibson, Loveland, CO (US); Eric R. Delano, Fort Collins, CO (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 10/714,258

(22) Filed: Nov. 14, 2003

(51) Int. Cl. G06F 11/00

(52) U.S. Cl. 714/38

(57) ABSTRACT

Microprocessor that includes a mechanism for detecting soft errors. The processor includes an instruction fetch unit for fetching an instruction and an instruction decoder for decoding the instruction. The mechanism for detecting soft errors includes duplication hardware for duplicating the instruction and comparison hardware. The processor further includes a first execution unit for executing the instruction in a first execution cycle and the duplicated instruction in a second execution cycle. The comparison hardware compares the results of the first execution cycle and the results of the second execution cycle. The comparison hardware can include an exception unit for generating an exception (e.g., raising a fault) when the results are not the same. The processor also includes a commit unit for committing one of the results when the results are the same.

### FIELD OF THE INVENTION

The present invention relates generally to detecting soft errors in processors, and more particularly, to an error detection method and system for processors that employ alternating threads.

### BACKGROUND OF THE INVENTION

Silicon devices are increasingly susceptible to “soft errors.” Soft errors are those errors caused by cosmic rays or alpha particle strikes. When these events occur, they cause an arbitrary node within the device (e.g., microprocessor) to change state. Unfortunately, these errors are transient in nature and may or may not be visible to the remainder of the system.

Many microprocessor designs add hardware to help detect “soft errors” and correct the “soft errors” if possible in order to increase reliability. Various techniques have been employed to detect these “soft errors.” An example of such a technique is to add parity to memory structures. While these techniques are effective for protecting memory structures, these techniques are not very effective to protect random control logic, execution datapaths and latches within the integrated circuit from “soft errors.”

One prior art technique to protect random control logic and the corresponding execution datapaths is referred to as “lockstepped cores” or “Functional Redundancy Check.” This technique involves running two or more processors in lock step. Since multiple microprocessors are executing the identical code, the same results are expected. When the results are compared and the results are not the same, a fault is raised. The lockstepped microprocessor cores are typically designated and operate as a master microprocessor and a checker microprocessor. The results of the master microprocessor and a checker microprocessor are continuously compared. Although this technique is effective in detecting many soft errors, this solution is expensive in that multiple processing elements are required to perform the check.

Based on the foregoing, there remains a need for an error detection method and system for processors that employ alternating threads that overcomes the disadvantages of the prior art as set forth previously.

### SUMMARY OF THE INVENTION

According to one embodiment of the present invention, a microprocessor that includes a mechanism for detecting soft errors is described. The processor includes an instruction fetch unit for fetching an instruction and an instruction decoder for decoding the instruction. The mechanism for detecting soft errors includes duplication hardware for duplicating the instruction and comparison hardware for comparing results. The processor further includes a first execution unit for executing the instruction in a first execution cycle and the duplicated instruction in a second execution cycle. The comparison hardware compares the results of the first execution cycle and the results of the second execution cycle. The comparison hardware can include an exception unit for generating an exception (raising a fault) when the results are not the same. The processor also includes a commit unit for committing one of the results when the results are the same.

According to another embodiment of the invention, a control register is provided for selectively enabling the error detection mechanism.

Other features and advantages of the present invention will be apparent from the detailed description that follows.

### BRIEF DESCRIPTION OF THE DRAWINGS

The present invention is illustrated by way of example, and not by way of limitation, in the figures of the accompanying drawings and in which like reference numerals refer to similar elements.

FIG. 1 illustrates an execution unit pipeline according to one embodiment of the present invention can be implemented.

FIG. 2 is a block diagram illustrating the error detection mechanism in accordance with one embodiment of the present invention.

FIG. 3 is a flow chart illustrating the steps performed by the error detection mechanism of FIG. 2 in accordance with one embodiment of the present invention.

FIG. 4 is a block diagram illustrating in greater detail the duplication mechanism of FIG. 2 in accordance with one embodiment of the present invention.

FIG. 5 is a state diagram for the select signal state machine of FIG. 4 in accordance with one embodiment of the present invention.

FIG. 6 is a block diagram illustrating in greater detail the comparison mechanism of FIG. 2 in accordance with one embodiment of the present invention FIG. 7 is a state diagram for the comparison mechanism of FIG. 6 in accordance with one embodiment of the present invention.

FIG. 8 illustrates a control register for use in enabling the error detection mechanism in accordance with one embodiment of the present invention.

FIG. 9 illustrates an exemplary portion of software code that includes instructions to enable and disable the error detection mechanism in accordance with one embodiment of the present invention.

FIG. 10 is a block diagram illustrating a circuit for handling load operations in accordance with one embodiment of the present invention.

FIG. 11 is a block diagram illustrating a circuit for handling store operations in accordance with one embodiment of the present invention.

### DETAILED DESCRIPTION

In the following description, for the purposes of explanation, numerous specific details are set forth in order to provide a thorough understanding of the present invention. It will be apparent, however, to one skilled in the art that the present invention may be practiced without these specific details. In other instances, well-known structures and devices are shown in block diagram form in order to avoid unnecessarily obscuring the present invention.

The system and method for detecting soft errors can be implemented in hardware, software, firmware, or a combination thereof. In one embodiment, the invention is implemented using hardware. The invention can be implemented with one or more of the following well-known hardware technologies: discrete logic circuits that include logic gates for implementing logic functions upon data signals, application specific integrated circuit (ASIC), a programmable gate array(s) (PGA), and a field-programmable gate array (FPGA).

Execution Unit Pipeline 100

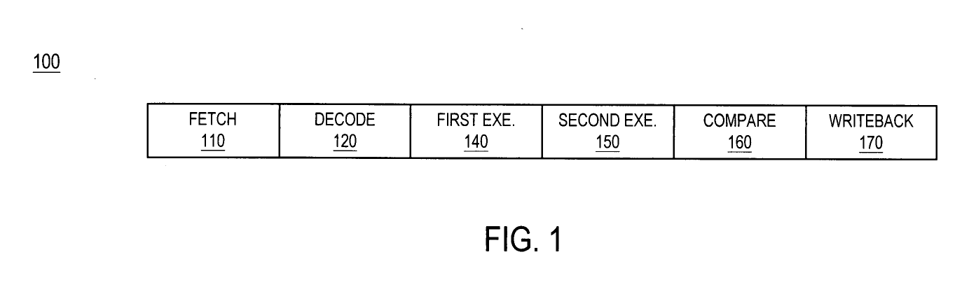

FIG. 1 illustrates an execution unit pipeline 100 according to one embodiment of the present invention. The execution unit pipeline 100 includes a fetch stage 110, a decode stage 120, a first execution (FIRST EXE.) stage 140, a second execution (SECOND EXE.) stage 150, a comparison stage 160 and a commit stage 170, which is also referred to as a write back stage. In the fetch stage 110, one or more instructions are fetched from an instruction cache. In the decode stage 120, the fetch instructions are decoded. The instruction can then be duplicated. For example, a leading thread and a trailing thread are generated. As described in greater detail hereinafter, the instructions may be latched for execution a second time instead of being duplicated. In the first execution stage 140, the decoded instruction (e.g., leading thread) is executed. In the second execution stage 150, the duplicated instruction (e.g., trailing thread) is executed. Both instructions are executed on the same hardware in the two different cycles. Preferably, the first and second instructions are executed in back-to-back cycles.

In the comparison stage 160, the results of the first execution stage 140 and the results of the second execution stage 150 are compared. When the results are the same, the results of either the first execution stage 140 or the results of the second execution stage 150 are committed (e.g., written back to memory or a register file) in the commit stage 170. When the results are not the same, a fault or exception is raised. Depending on the policy of committing the leading thread's results, the fault may be recoverable by flushing the instructions and re-executing the instructions in the commit stage 170.

Error Detection Mechanism

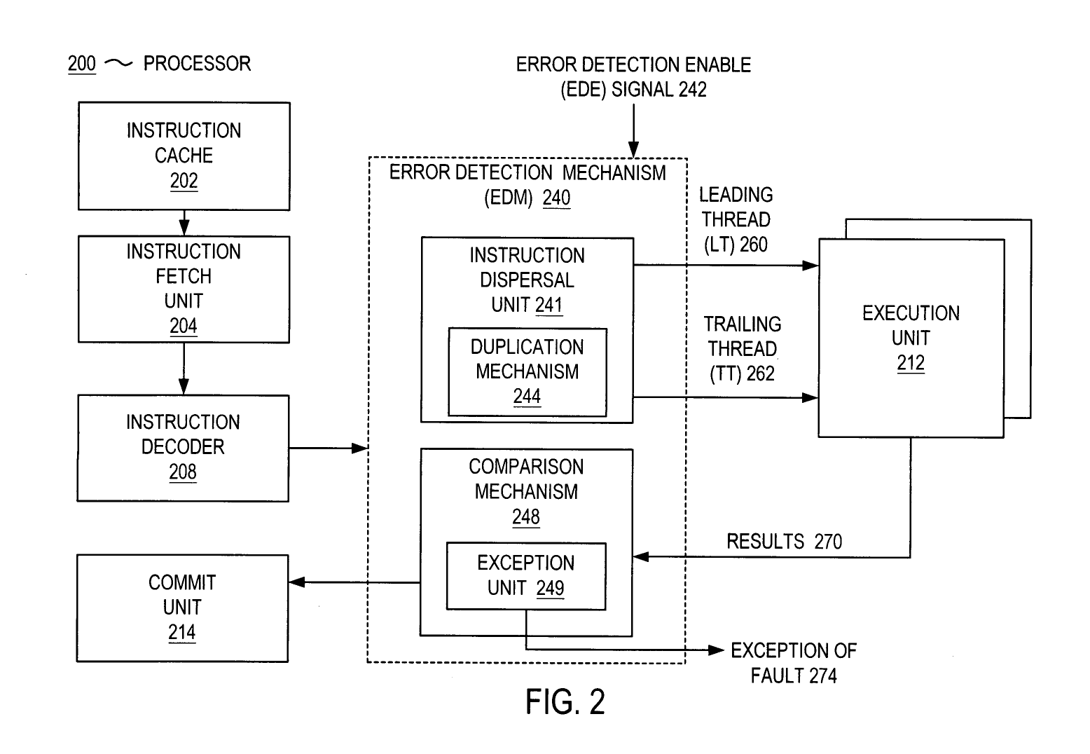

FIG. 2 is a block diagram illustrating a processor 200 that includes the error detection mechanism 240 in accordance with one embodiment of the present invention. The processor 200 includes an instruction cache 202 for storing instructions, an instruction fetch unit 204 for fetching an instruction, and an instruction decoder 208 for decoding the instruction.

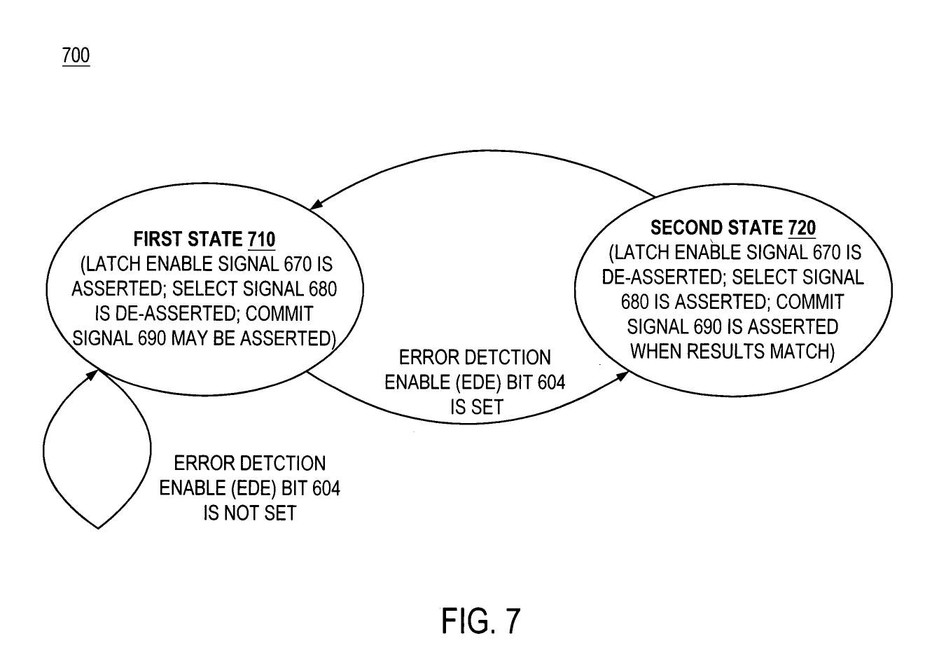

The processor 200 also includes the error detection mechanism 240 for detecting soft errors. The error detection mechanism 240 is selectively enabled by an error detection enable signal 242. The generation and control of the error detection enable signal 242 are described in greater detail hereinafter with reference to FIG. 8. When enabled, the error detection mechanism 240 performs the duplication and comparison as described herein. When the error detection mechanism 240 is not enabled, the processor operates in the normal fashion without checking for soft errors.

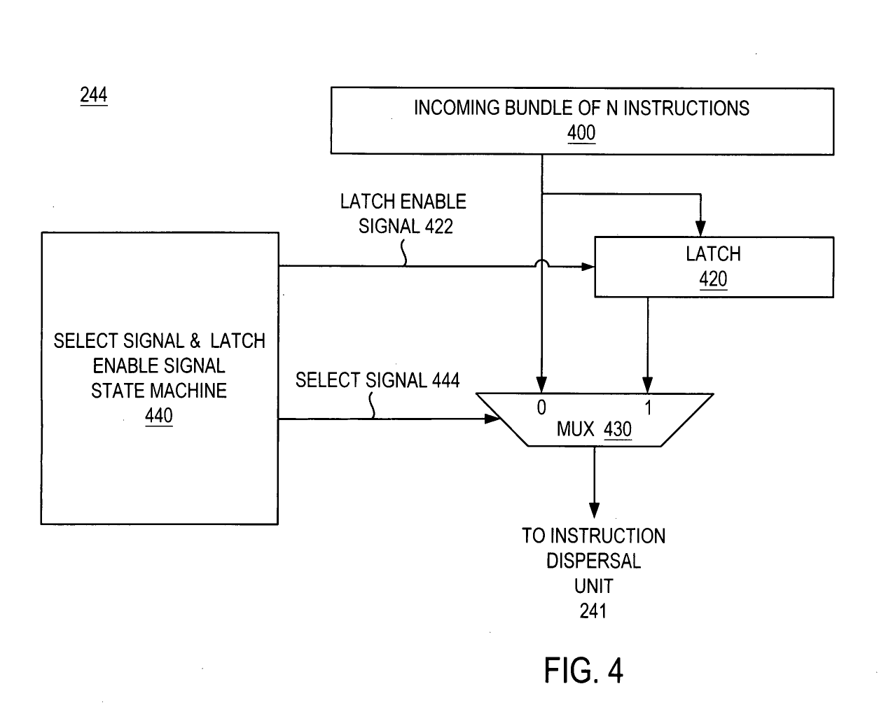

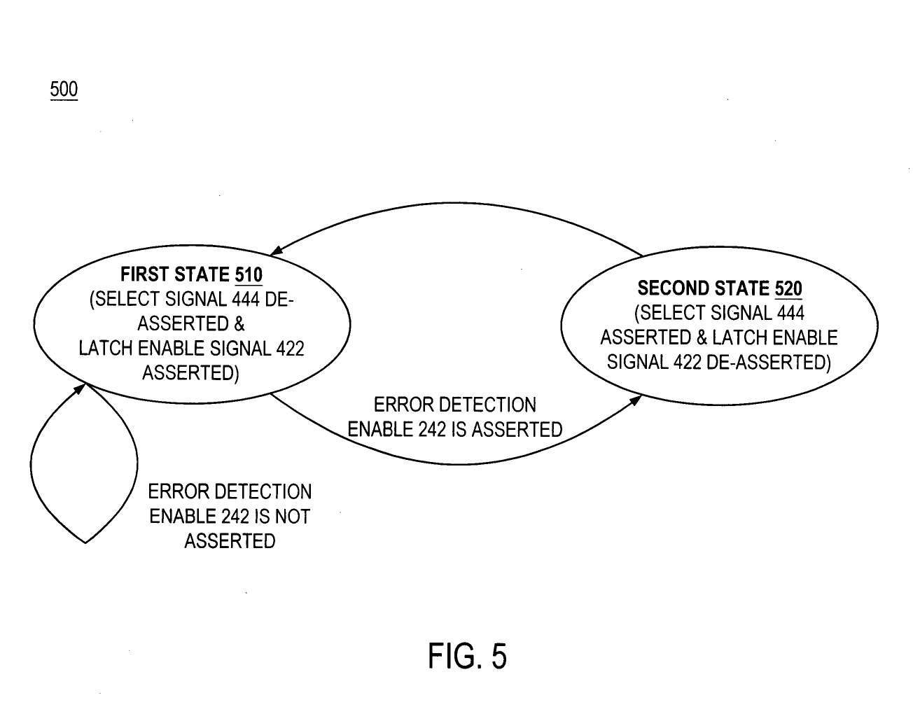

The error detection mechanism 240 includes an instruction dispersal unit 241 for providing instructions (e.g., a leading thread 260 of instructions and a trailing thread 262 of instructions). The error detection mechanism 240 includes a duplication mechanism 244 for duplicating instructions (e.g., generating a trailing thread (TT) 262 as described hereinafter) and a comparison mechanism 248. The duplication mechanism 244 can reside in the instruction dispersal unit 241 as shown or can be disposed elsewhere in the error detection mechanism 240. An exemplary implementation of the duplication mechanism 244 is described in greater detail hereinafter with reference to FIGS. 4 and 5.

The processor 200 also includes at least one execution unit (e.g., first execution unit 212) for executing an instruction (or bundle of instructions denoted leading thread (LT) 260) in a first execution cycle. The first execution unit 212 also executes the duplicated instruction (or bundle of instructions denoted trailing thread (TT) 262) in a second execution cycle. In one embodiment, the processor has an in-order execution architecture, and the duplicated instruction (e.g., the trailing thread (TT) 262) is executed in a subsequent cycle immediately following the cycle in which the leading thread is executed. The first execution unit 212 can include, but is not limited to, a floating point unit (FPU), an integer unit, an arithmetic logic unit (ALU), a multimedia unit, and a branch unit.

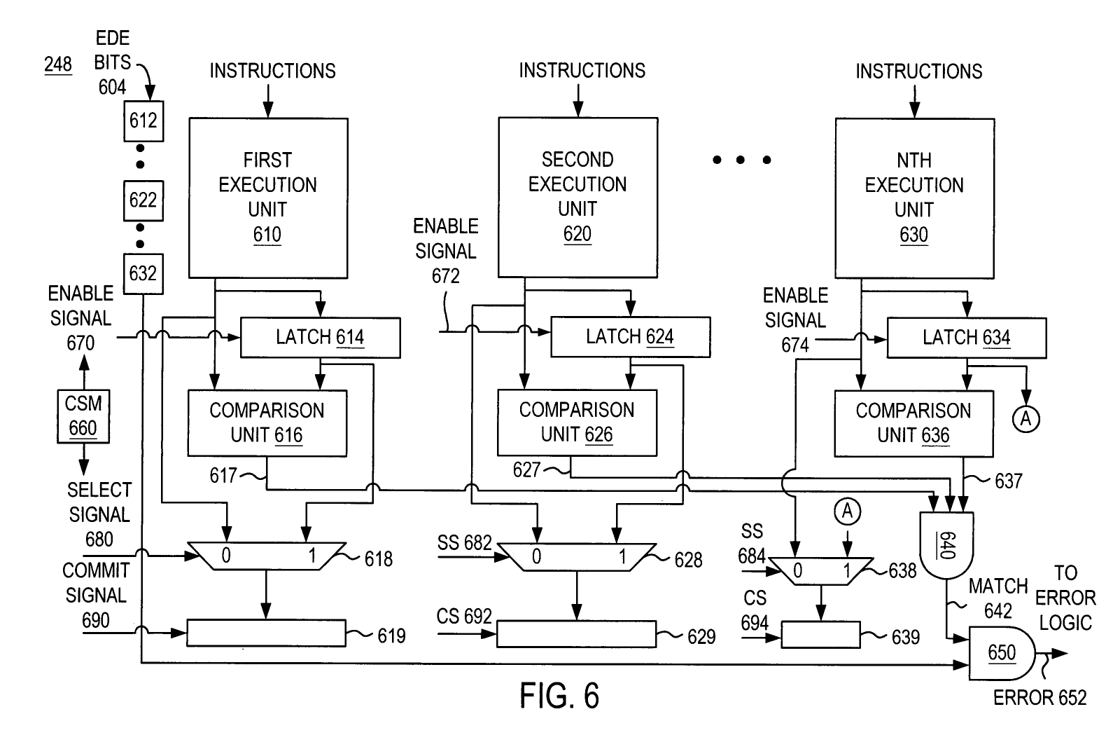

The error detection mechanism 240 also includes a comparison mechanism 248 for comparing the results of the first execution cycle and the results of the second execution cycle. The comparison mechanism 248 includes an exception unit 249 for generating an exception 274 (raising a fault) when the results are not the same. An exemplary implementation of the comparison mechanism 248 is described in greater detail hereinafter with reference to FIGS. 6 and 7.

The processor 200 also includes commit unit 214 for committing one of the results when the results of the first execution cycle are the same as the results of the second execution cycle.

### Processing Steps Performed by the Error Detection Mechanism 240

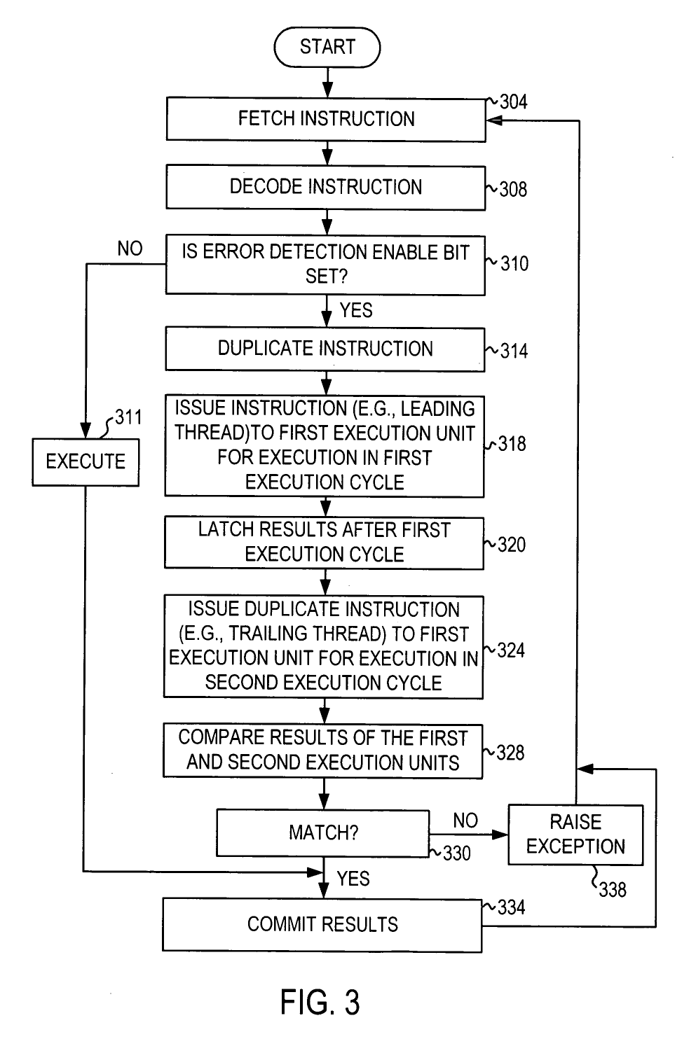

FIG. 3 is a flow chart illustrating the steps performed by the error detection mechanism of FIG. 2 in accordance with one embodiment of the present invention. In step 304, an instruction is fetched. In step 308, the instruction is decoded. In decision block 310, a determination is made whether error detection is enabled (e.g., whether error detection bit 242 is set). When error detection is not enabled, the instruction is executed in step 311. After execution processing proceeds to step 334, where the results of execution are committed.

When error detection is enabled, processing proceeds to step 314. In step 314, the instruction is duplicated (e.g., latched in an instruction latch as described in greater detail hereinafter). In step 318, the instruction is issued for execution in a first execution cycle to a first execution unit.

In step 320, the results of the execution are latched after the first execution cycle. In step 324, the duplicated instruction is issued to the first execution unit for execution in a second execution cycle. In one embodiment, the processor has an in-order execution design, and the second execution cycle immediately follows the first execution cycle.

In step 328, the results of the first execution cycle and the results of the second execution cycle are compared. In decision block 330, a determination is made whether the results of the first execution cycle and the results of the second execution cycle are the same (e.g., whether the results match). When the results of the first execution cycle and the results of the second execution cycle are the same, the results (e.g., the result of the first execution cycle or the result of the second execution cycle) are committed in step 334. For example, when the results are the same, one of the results may be written back to memory or a register file.

When the results of the first execution cycle and the results of the second execution cycle are not the same, an exception is raised in step 338. Processing then proceeds to step 304, where another instruction is fetched.

Duplication Mechanism

FIG. 4 is a block diagram illustrating in greater detail the duplication mechanism 244 of FIG. 2 in accordance with one embodiment of the present invention. The duplication mechanism 244 includes the incoming instruction bundle of N instructions 400 that contains the instructions to be executed. The instruction bundle 400 provides a new instruction to the instruction dispersal unit 241 for execution in a first execution cycle.

The duplication mechanism 244 also includes a duplication state machine 440 for generating a latch enable signal 422 and a select signal 444. The duplication state machine 440 is described in greater detail hereinafter with reference to FIG. 5, which is a state diagram of the state machine 440.

The duplication mechanism 244 also includes a latch 420 for receiving the incoming instruction bundle 400. The latch 420 is controlled by the latch enable signal 422. The latch 420 stores a copy of the instruction that is utilized for execution in a second execution cycle. When the latch enable signal 422 is asserted, the latch 420 latches instructions from the instruction bundle 400. When the latch enable signal 422 is de-asserted, the latch 420 maintains the current instructions. In one embodiment, a new instruction is latched every other clock cycle when error detection is enabled.

The duplication mechanism 244 also includes a multiplexer (MUX) 430. The MUX 430 includes a first input (0) for receiving an instruction bundle 400, a second input (1) for receiving a duplicate instruction from the latch 420, a control input for receiving the select signal 444, and an output. The state of the select signal 444 determines which of the inputs (0 or 1) is provided at the output. When the select signal 444 is asserted, the instruction from the latch 420 (e.g., the duplicate instruction) is provided to the instruction dispersal unit 241. When the select signal 444 is de-asserted, the incoming instruction bundle 400 is provided to the instruction dispersal unit 241. The combination of the latch 420, the MUX 430, and the two enable signals 422 and 444 effectively throttles the front-end of the machine, issuing a new instruction to the instruction dispersal unit 241 every two cycles.

FIG. 5 is a state diagram 500 for the duplication state machine 440 of FIG. 4 in accordance with one embodiment of the present invention. The state diagram 500 includes a first state 510 and a second state 520. The state machine 440 remains in the first state 510 when the EDE signal 242 is not asserted (i.e., the error detection mechanism is not enabled and instruction duplication is not performed). When not duplicating, the instruction bundle is passed through to the instruction dispersal unit 241.

The state machine 440 transitions from the first state 510 to the second state 520 when the error detection enable (EDE) signal 242 is asserted. When in the second state 520, the state machine 440 asserts the select signal 444 and de-asserts latch enable signal 422. For example, in the second state 520, the first latch 400 and the second latch 420 hold their current values. The state machine 440 then transitions from the second state 520 to the first state 510. When in the first state 510, the state machine 440 de-asserts the select signal 444 and asserts the latch enable signal 422. For example, in the first state 510, the latch 420 is enabled. When duplicating, the output of the multiplexer 430 alternates between bundle 0 and bundle 1. In effect, each instruction bundle is duplicated and issued twice. In this regard, a new instruction bundle is processed in every other clock cycle.

Comparison Mechanism Integrated into Each Execution Unit

Another novel aspect of the invention is the integration of a comparison mechanism into each execution unit. For example, each execution unit includes a register for temporarily storing the results of the leading thread. In this manner, when the results of the trailing thread are made available, the results may be compared with the stored results.

FIG. 6 is a block diagram illustrating in greater detail the comparison mechanism 248 of FIG. 2 in accordance with one embodiment of the present invention. The comparison mechanism 248 includes a comparison state machine (CSM) 660 for generating a latch enable signal 670, a select signal 680, and a commit signal 690. The comparison state machine (CSM) 660 is described in greater detail hereinafter with reference to FIG. 7, which is a stage diagram of the CSM 660.

The comparison mechanism 248 further includes a latch 614 and a comparison unit 616 for comparing the output of the latch 614 and the output of the first execution unit 610. The latch 614 is enabled by the latch enable signal 670. The comparison mechanism 248 also includes a multiplexer (MUX) 618. The multiplexer (MUX) 618 includes a first input for receiving the output of the latch 614, a second input for receiving the output of the execution unit 610, and a control input for receiving the select signal 680. Based on these inputs, the MUX 618 selectively provides one of the inputs as an output. For example, either the result from the execution unit 610 or the result from the latch 614 is provided as the output of the MUX 618 based on the select signal 680.

A latch 619 is also provided to latch the output of the MUX 618 when the commit signal 690 is asserted. Similarly, a latch 624, a comparison unit 626, a MUX 628 that is controlled by select signal (SS) 682, and a latch 629 that is controlled by commit signal (CS) 692 are provided for processing results generated by the second execution unit 620. Furthermore, a latch 634, a comparison unit 636, a MUX 638 that is controlled by select signal (SS) 684, and a latch 639 that is controlled by commit signal (CS) 694 are provided for processing results generated by the Nth execution unit 630. It is noted that the MUXs 618, 628, 638 are optional.

The comparison mechanism 248 includes a plurality 604 of error detect enable bits (EDE) that are also referred to herein as compare valid bits. For example, there can be an error detect enable (EDE) bit for each instruction executed by each execution unit.

In this embodiment, the comparison mechanism 248 includes a plurality of EDE bits 604. The plurality of EDE bits 604 can include a first compare valid bit 612 that is associated with a first instruction, a second compare valid bit 622 that is associated with a second instruction, and an M^{th} compare valid bit 632 is associated with an M^{th} instruction. It is noted that the first instruction, the second instruction, and the M^{th} instruction are executed by the first execution unit 610.

It is noted that there can be provided according to the invention a second plurality of bits that correspond to instructions executed by the second execution unit 620 and a third plurality of bits that correspond to instructions executed by the third execution unit 630. Each plurality of bits can include a first compare valid bit that is associated with a first instruction, a second compare valid bit that is associated with a second instruction, and an M^{th} compare valid bit is associated with an M^{th} instruction.

The comparison mechanism 248 also includes comparison units (e.g., comparison unit 616, 626, and 636) that are associated with a respective execution unit. For example, the comparison unit 616 receives a first result from the latch 614 and a second result from the first execution unit 610, compares the first result and the second result, and generates a signal (e.g., signal 617) that indicates whether the results are the same. Each execution unit (e.g., execution unit 610, 620, and 630) executes an instruction twice to generate a first result that is stored in a latch (e.g., latch 614, 624, and 634) and to generate a second result that is provided directly to a comparison unit (e.g., comparison unit 616, 626, and 636). Signals 627 and 637 are generated (e.g., selectively asserted) by comparison units 626, and 636, respectively, based on the results of the comparison.

The comparison units (e.g., comparison unit 616, 626, and 636) for comparing results can be implemented with OR gates or NOR gates. For example, when the first result and the second result are the same, the output of the comparison unit (e.g., comparison unit 616, 626, and 636) can be asserted (e.g., a logic high).

The comparison mechanism 248 also includes a first AND gate 640 that includes a first input for receiving the compare valid bit associated with the first execution unit 610, a second input for receiving the compare valid bit associated with the second execution unit 620 and a third input for receiving the compare valid bit associated with the Nth execution unit 630. The output of the first AND gate 640 generates a match signal 642 that is provided to a second AND gate 650. It is noted that the match signal 642 is de-asserted when there is a mismatch or discrepancy in the results of any of the execution units.

The second AND gate 650 includes a first input for receiving the match signal 642 from the first AND gate 640 and a second input for receiving the EDE bits 604. The second AND gate 650 generates an error signal (e.g., a de-asserted error signal) 652 when the error detection is enabled, but there is a mismatch in one of the results from one of the comparison units. The error signal 652 may be provided to error logic (e.g., the exception unit 249), which can then use the error signal 652 to determine whether to commit the results. When the results are to be committed, the results 270 may then be provided to a destination (e.g., register file, latches 619, 629, and 639).

FIG. 7 is a state diagram 700 for the compare state machine (CSM) 660 of FIG. 6 in accordance with one embodiment of the present invention. The state diagram 700 includes a first state 710 and a second state 720.

The state machine transitions from the first state 710 to the second state 720 when the error detect enable (EDE) bit 242 is set or asserted. When in the second state 720, the state machine asserts the select signal 680 and de-asserts the enable signal 670. For example, in the second state 720, the results from the latch 614 and results from the execution unit 610 are compared, and the results are committed when the results match. The commit signal 690 is asserted when the results of the leading thread 260 and the results of the trailing thread 262 (e.g., duplicate instruction) are the same.

The state machine then transitions from the second state 720 to the first state 710. When in the first state 710, the state machine de-asserts the select signal 680 and asserts the enable signal 670. For example, in the first state 710, the result latches (e.g., 614, 624, 634) are enabled.

For example, the result latches (e.g., 614, 624, 634) may be enabled every other clock cycle when the error detection enable bit is set. When the error detection mechanism is enabled (e.g., when the error detection enable bit is set), the results are committed every other cycle. However, when the error detection mechanism is not enabled (e.g., when the error detection enable bit is not set), it is always possible to commit the results that come out of the execution units.

### Error Detection Enable (EDE) Bit In a Control Register For Selectively Enabling the Error Detection Mechanism

It is noted that the error detection mechanism according to the invention may be enabled by employing an enable mechanism. For example, when the error detection mechanism is enabled by utilizing an error detection enable bit in a control register as described with reference to FIG. 8, the error detection enable bit may be set or cleared by an enable mechanism. The enable mechanism can be, but is not limited to, hardware, an operating system, firmware (e.g., user-programmed firmware), or by an application.

FIG. 8 illustrates a control register 800 for use in enabling the error detection mechanism in accordance with one embodiment of the present invention. The control register 800 includes an error detection enable (EDE) bit 810. The error detection enable (EDE) bit 810 may be set and cleared by firmware 820 (e.g., user programmed firmware), by the operating system (OS) 830, or by an application 840. The error detection enable (EDE) bit 810 can utilized to provide the error detection signal 242 that selectively enables the error detection mechanism of the invention.

Prior art approaches to functional redundancy checking (FRC) do not provide the user the ability to selectively turn the functional redundancy checking on or off. One novel aspect of the invention is the provision of a mechanism for allowing a user to selectively enable and disable the error detection mechanism of the invention. For example, a programmer can designate that only certain portions of code to be subject to the error detection and error checking. The non-designated portions of code can be processed without checking for soft errors.

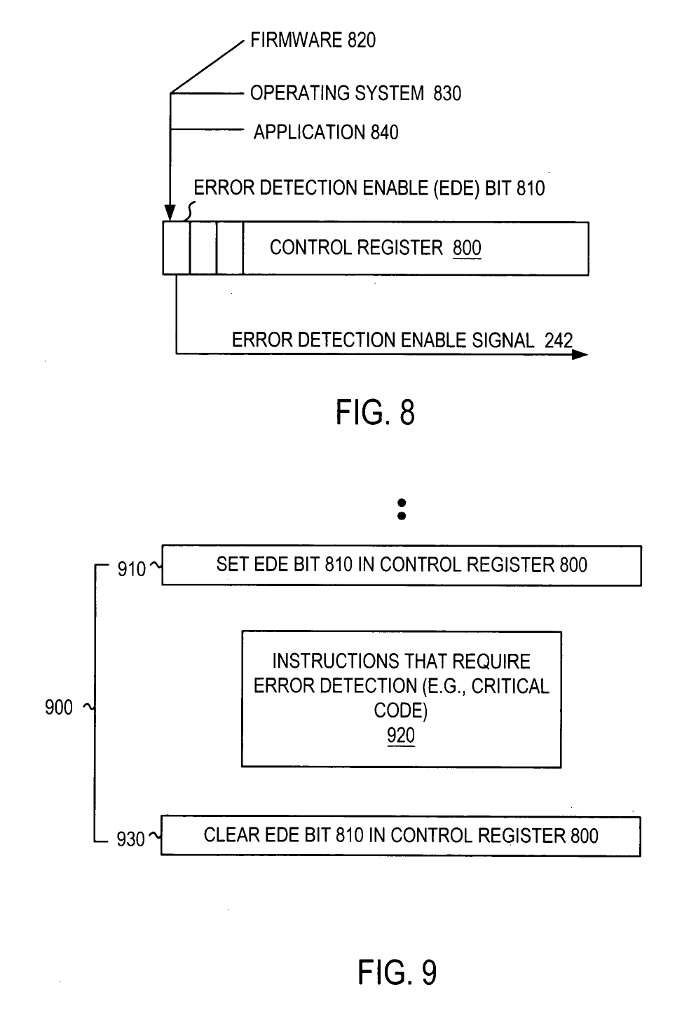

FIG. 9 illustrates an exemplary portion 900 of software code that includes instructions to enable and disable the error detection mechanism in accordance with one embodiment of the present invention. The portion 900 includes a first instruction 910 for setting the EDE bit 810 in the control register 800 and a second instruction 930 for clearing the EDE bit 810 in the control register 800. Once the EDE bit 810 is set, the error detection mechanism of the invention is enabled to detect soft errors in critical code 920. The software code prior to instruction 910 and the code subsequent to instruction 930 are not subject to error detection by the error detection mechanism of the invention. In this manner, the error detection mechanism of the invention can be selectively enabled to only check certain portions of code, thereby allowing a programmer to balance processor performance and processor reliability for mission critical portions of code. Alternatively, special instructions that marks the beginning and/or end of a sequence of instructions that are to be checked may be employed.

Selectively Checking A Critical Portion of Code for Soft Errors

In one embodiment, a portion of critical code that includes a first instruction and a last instruction requires checking for soft errors. In this embodiment, the error detection mechanism for checking for soft errors is enabled according to the invention for checking the portion of critical code. For example, the error detection mechanism is enabled before the first instruction of the critical code and cleared after the last instruction of the critical code. In this manner, the portion of critical code may be selectively subject to error detection by asserting the error detection enable bit.

It is noted that certain sections of code are difficult to make redundant or error resilient. These sections of code can be protected by lower performance, but higher reliability, lockstep execution while other less important code is executed at higher performance levels and lower reliability.

The enable mechanism according to the invention advantageously provides the ability and flexibility to have the error detection mechanism selectively enabled and disabled, thereby allowing a programmer to balance performance of the processor with the detection of soft errors.

Handling Memory Operations

The error detection mechanism according to the invention provides special handling hardware for operations directed to a memory system (e.g., a cache). For store operations, the data and address of each of the store operations are latched and compared in two subsequent cycles. When the data and addresses match, the first store operation is executed. Handling hardware ensures that the second store operation is not sent to the memory system. Otherwise, when the data or the addresses do not match, no store operations are sent to the memory, and an exception is raised.

For load operations, the address of the first load operation and the address of the second load operation are compared. When there is a match, the first load operation is executed. When there is no match, an exception is raised. In one embodiment, hardware is provided to ensure that the first load is executed, but the second load is not executed. Since time needed for memory operations is a major factor in computing latency and determining processor performance, by ensuring that load operations are performed only once, the performance of the processor is increased.

Load Handling Mechanism

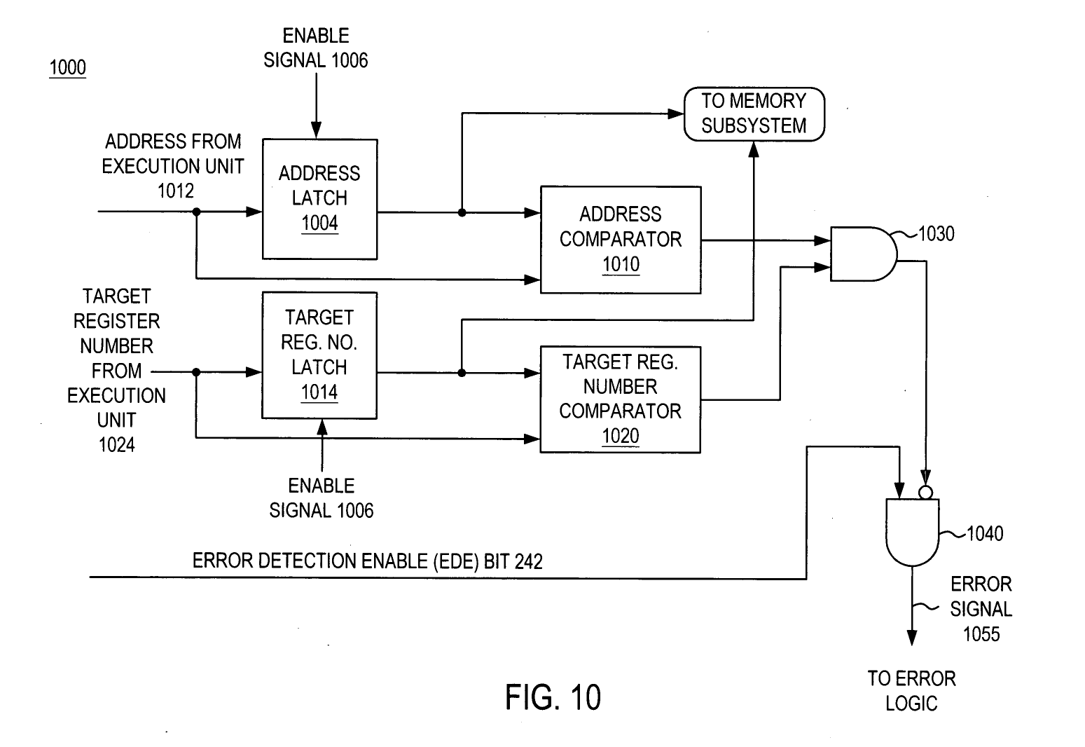

FIG. 10 is a block diagram illustrating a circuit 1000 for handling load operations in accordance with one embodiment of the present invention. The load handling mechanism 1000 includes an address latch 1004 that has a first input for receiving an address 1012 from the execution unit and a second input for receiving an enable signal 1006. When asserted, the enable signal 1006 causes the address latch 1004 to latch the address 1012. The enable signal 1006 is controlled by the same or similar mechanism illustrated in FIG. 7.

The load handling mechanism 1000 includes an address comparator 1010 for comparing the address received from the address latch 1004 and the address 1012 received directly from the execution unit.

The load handling mechanism 1000 includes a target register number latch 1014 that has a first input for receiving a target register number 1024 from the execution unit and a second input for receiving the enable signal 1006. When asserted, the enable signal 1006 causes the target register number latch 1004 to latch the target register number 1024.

The load handling mechanism 1000 also includes a target register bit comparator 1020 for comparing the target register number received from the target register number latch 1014 and the target register number 1024 received directly from the execution unit.

The load handling mechanism 1000 also includes a first AND gate 1030 and second AND gate 1040. The first AND gate 1030 includes a first input for receiving the output of the address comparator 1010, a second input for receiving the output of the target register number comparator 1020, and an output for generating an output signal.

The second AND gate 1040 includes a first input for receiving a compare enable signal (e.g., comparison enable bit from FIG. 6) from the execution unit and an inverted input for receiving the output signal from the first AND gate 1030, and an output for generating an error signal 1050 that can be provided to error logic. For example, an asserted error signal can indicate that an error has been detected. The address 1012 and the first target register number 1024 are provided to a memory subsystem.

The enable signal 1006 can be the same as that illustrated in FIG. 6 and generated in the same manner. The address/target register may be released to the memory subsystem every second cycle. This is analogous to the commit signal shown in FIG. 6. It is noted that the state machine illustrated in FIG. 7 may be utilized to control this process. For example, the latch enable signal of FIG. 7 can be coupled to provide signal 1006.

Store Handling Mechanism

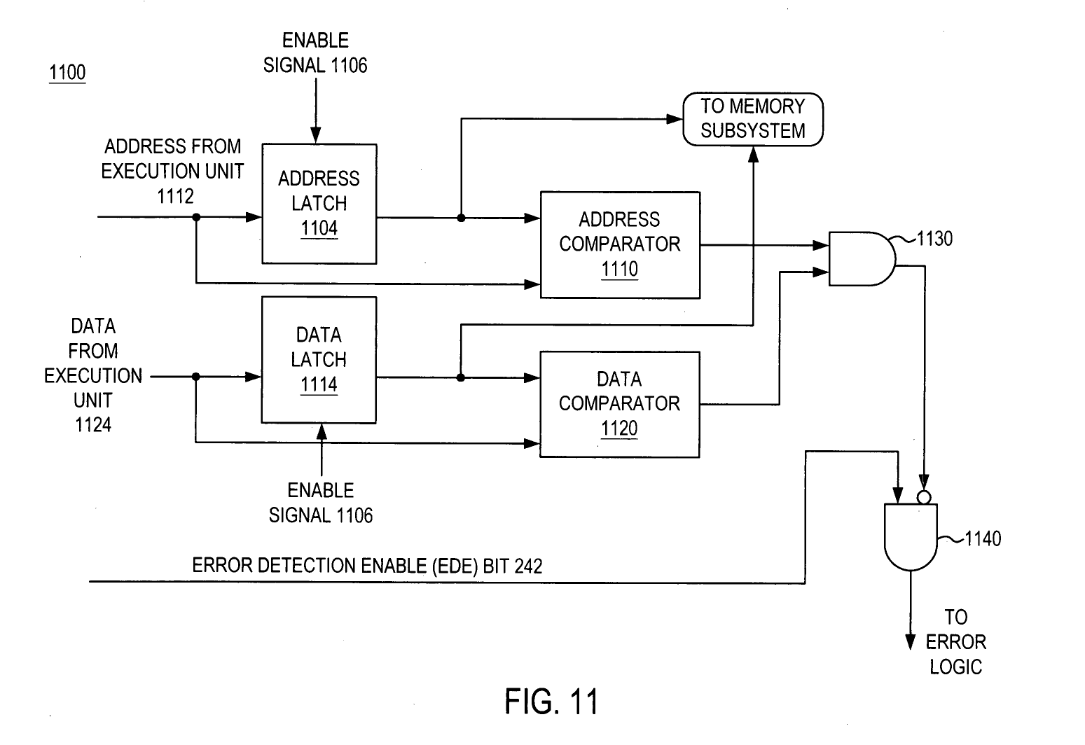

For store operations, the data and address of each of the store operations are latched and compared in two subsequent cycles. When the data and addresses match, the first store operation is executed. Handling hardware ensures that the second store operation is not sent to the memory system. Otherwise, when the data or the addresses do not match, no store operations are sent to the memory, and an exception is raised. FIG. 11 is a block diagram illustrating a circuit 1100 for handling store operations in accordance with one embodiment of the present invention. The store handling mechanism 1100 includes an address latch 1104 that has a first input for receiving an address 1112 from the execution unit and a second input for receiving an enable signal 1106. When asserted, the enable signal 1106 causes the address latch 1104 to latch the address 1112.

The store handling mechanism 1100 includes an address comparator 1110 for comparing the address received from the address latch 1104 and the address 1112 received directly from the execution unit.

The store handling mechanism 1100 also includes a data comparator 1120 for comparing a data 1124 from the first execution unit and data 852 from the second execution unit.

The store handling mechanism 1100 also includes a first AND gate 1130 and second AND gate 1140. The first AND gate 1130 includes a first input for receiving the output of the address comparator 1110, a second input for receiving the output of the data comparator 1120, and an output for generating an output signal.

The second AND gate 1140 includes a first input for receiving a first compare enable signal 1144 (e.g., an error detection enable signal) from the first execution unit, a second input for receiving a second compare enable signal 1154 (e.g., an error detection enable signal) from the second execution unit, a third inverted input for receiving the output signal from the first AND gate 1130, and an output for generating an error signal. For example, an asserted error signal can indicate that an error has been detected. The error signal can be provided to error logic. The first and second compare enable signals can be, for example, the error detection enable signal 242.

The address and the data from the first execution unit are provided to a memory subsystem. It is noted that the second store (e.g., the address and data from the second execution unit) is squashed according to the invention unless the memory subsystem is designed and configured to handle a second store (e.g., to detect and to discard a second store). For example, the address and the data can be discarded by the store handling mechanism 800 according to the invention. It is noted that in an alternative embodiment, the first store can be squashed and the second store allowed to execute. In this embodiment, the logic to detect an error can be modified to accommodate such an embodiment.

The enable signal 1106 can be the same as that illustrated in FIG. 6 and generated in the same manner. The address/target register may be released to the memory subsystem every second cycle. This is analogous to commit signal shown in FIG. 6. It is noted that the state machine illustrated in FIG. 7 may be utilized to control this process.

In the foregoing specification, the invention has been described with reference to specific embodiments thereof. It will, however, be evident that various modifications and changes may be made thereto without departing from the broader scope of the invention. The specification and drawings are, accordingly, to be regarded in an illustrative rather than a restrictive sense.

1. A processor that includes a mechanism for detecting soft errors comprising:
a) instruction fetch unit for fetching an instruction;
b) an instruction decoder for decoding the instruction;
c) duplication hardware for duplicating the instruction;
d) a first execution unit for executing the instruction in a first execution cycle;
e) the first execution unit executing the duplicated instruction in a second execution cycle;
f) comparison hardware for comparing the results of the first execution cycle and the results of the second execution cycle; and
g) a commit unit for committing one of the results when the results are the same; and
h) an exception unit for generating an exception (raising a fault) when the results are not the same.

2. The processor of claim 1
wherein the step of executing the instruction in a first execution cycle includes the step of storing the results of the first execution cycle.

3. The processor of claim 1
wherein the step of executing the instruction in the first execution cycle includes issuing the decoded instruction to a first execution unit; and
wherein the step of executing the instruction in the second execution cycle includes issuing the decoded instruction to the first execution unit.

4. The processor of claim 3
wherein the first execution unit is one of floating point unit, an integer unit, a arithmetic logic unit (ALU), a multimedia unit, and a branch unit.

5. The processor of claim 1 further comprising:
a control register that includes a bit for enabling the duplication hardware and comparison hardware.

6. The processor of claim 5 wherein the bit is set by one of user-programmed firmware and an operating system.

7. (canceled)

8. A method for detecting errors in a processor comprising the steps of:
a) fetching an instruction;
b) decoding the instruction;
c) duplicating the instruction;
d) executing the instruction in a first execution cycle;
e) executing the duplicated instruction in a second execution cycle;
f) comparing the results of the first execution cycle and the results of the second execution cycle; and
g) when the results are the same, committing one of the results; and
h) when the results are not the same, raising a fault.

9. The method of claim 8
wherein the step of executing the instruction in a first execution cycle includes the step of storing the results of the first execution cycle.

10. The method of claim 8
wherein the step of executing the instruction in the first execution cycle includes issuing the decoded instruction to a first execution unit; and
wherein the step of executing the instruction in the second execution cycle includes issuing the decoded instruction to the first execution unit.

11. The method of claim 8
wherein the execution unit is one of floating point unit, an integer unit, an arithmetic logic unit (ALU), a multimedia unit, and a branch unit.

12. The method of claim 8 wherein duplication hardware is provided for performing the instruction duplication and comparison hardware is provided for performing the comparison, the method further comprising the step of:
setting a bit in a control register;
wherein the bit enables the duplication hardware and comparison hardware.

13. The method of claim 12 wherein the bit is set by one of user-programmed firmware and an operating system.

14. A method for selectively enabling an error detection mechanism that employs alternating threads, comprising the steps of:
a) maintaining a control register that includes an error detection enable bit;
b) setting the error detection enable bit to enable the error detection mechanism; and
c) clearing the error detection enable bit to disable the error detection mechanism.

15. The method of claim 14 wherein the step of setting the error detection enable bit to enable the error detection mechanism includes one of
a user-programmed firmware setting the error detection enable bit to enable the error detection mechanism;
an operating system setting the error detection enable bit to enable the error detection mechanism; and
an application setting the error detection enable bit to enable the error detection mechanism; and
wherein the step of clearing the error detection enable bit to disable the error detection mechanism includes one of a user-programmed firmware clearing the error detection enable bit to enable the error detection mechanism;
an operating system setting clearing the error detection enable bit to enable the error detection mechanism; and
an application clearing the error detection enable bit to enable the error detection mechanism.

16. The method of claim 14 wherein the error detection mechanism is enabled for a portion of critical code that includes a first instruction and a last instruction;
wherein the step of setting the error detection enable bit to enable the error detection mechanism includes the step of setting the error detection enable bit to enable the error detection mechanism prior to the execution of the first instruction of the critical portion of code; and
wherein clearing the error detection enable bit to disable the error detection mechanism includes
clearing the error detection enable bit to disable the error detection mechanism after the execution of the last instruction of the critical portion of code.

17. An apparatus for executing instructions comprising:
a) a control register that includes an error detection enable bit;
b) an error detection mechanism for detecting soft errors; and
c) a mechanism for selectively enabling the error detection mechanism by setting the error detection enable bit to enable the error detection mechanism and by clearing the error detection enable bit to disable the error detection mechanism; wherein the error detection mechanism employs alternating threads.

18. The apparatus of claim 17 wherein the selective enabling mechanism is one of a user-programmed firmware, an operating system, and an application.

19. The apparatus of claim 17 wherein the error detection mechanism is enabled for a portion of critical code that includes a first instruction and a last instruction;
wherein the selective enabling mechanism sets the error detection enable bit to enable the error detection mechanism prior to the execution of the first instruction of the critical portion of code; and
wherein the selective enabling mechanism clears the error detection enable bit to disable the error detection mechanism after the execution of the last instruction of the critical portion of code.
